(19) United States
(12) Patent Application Publication
(10) Pub. No.: US 2024/0051617 A1
(43) Pub. Date: Feb. 15, 2024

(54) HIDDEN RACK SYSTEM

(71) Applicants: Frank Puente, Harlingen, TX (US); Julio C. Mendoza, Brownsville, TX (US)

(72) Inventors: Frank Puente, Harlingen, TX (US); Julio C. Mendoza, Brownsville, TX (US)

(21) Appl. No.: 17/886,705

(22) Filed: Aug. 12, 2022

(51) Int. Cl. B62D 33/02

(52) U.S. Cl. CPC B62D 33/0207

(57) ABSTRACT

The present invention generally relates to a hidden rack system. More specifically, the present invention relates to systems and methods for a hidden telescoping rack system to be utilized in the bed of a truck or other mountable vehicles or objects.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a hidden rack system. More specifically, the present invention relates to systems and methods for a hidden telescoping rack system to be utilized in the bed of a truck.

### BACKGROUND OF THE INVENTION

Without limiting the scope of the disclosed systems and methods, the background is described in connection with a novel system and methods for a hidden rack system.

Trucks and truck beds are utilized for a multitude of purposes, however standard truck beds may present limitations based on the limited surface space available. To allow for additional equipment, cargo, or other items to be carried, numerous truck bed rack systems exist.

Current truck bed rack systems are large, set in a fixed position, and are not easily removable from the truck bed once installed. The truck bed rack systems currently available are often unsightly, and can be cumbersome when not in use.

The present invention eliminates the rigid, fixed systems of current rack systems and provides a flexible, multi-positional system that can be hidden when not in use. Unlike current systems which are often composed of multiple components to create a single device that is only available to be used in a single position, the hidden rack systems are independent of each other, and when multiple are utilized in the same truck bed, it provides full flexibility of use and adjustability.

The present invention therefore proposes a novel systems and methods for a hidden rack system that addresses the shortcomings of the prior art.

### BRIEF SUMMARY OF THE INVENTION

The present invention, therefore, provides systems and methods for a hidden rack system.

The hidden rack system in an embodiment, is comprised of: at least three interlocking and telescoping members. The system can be extended to multiple heights, allowing for full flexibility of use. When the system is fully compressed, it sits below the side wall of the truck bed so it is fully hidden from view when observing the truck bed from a perspective view.

The base member is the widest in area, so it is able to house the top members when they are compacted. The base member is mounted to the bed of the truck by attachment means, providing stability to the hidden rack system. The base member is also rotatable around the vertical axis 360 degrees to provide further adaptability and customization to the user's needs.

The intermediate member is smaller in area than the base member but larger in area than the top member. The intermediate member need not be extended to utilize the hidden rack system.

The top member is narrowest in area so that it can be housed in the member below it. The top member contains a fixed, horizontal member, positioned 90 degrees from the vertical axis of the device. The top member may be extended without extending the intermediate member below it.

The hidden rack is extendable by pulling a spring-loaded pin to disengage a member from the member below it. Once the member is extended to its desired height, the spring-loaded pin returns to its unloaded position, and there are threaded knobs that interlock the members into the extended position.

The hidden rack system is composed of a rigid material such as but not limited to, 316 stainless steel, in order to support heavy loads, and to withstand elements and use over time. A layer of a friction reducing material such as but not limited to Nylatron GS, will coat the portions of the members which slide to extend and house another member.

The hidden rack system can be mounted in various locations in the truck bed. Further, anywhere from a single rack system to an array of hidden rack systems may be used at once. Each hidden rack system is independent of the other, allowing for each hidden rack system to be adjusted to varying heights and rotational positions if desired. Additionally, the hidden rack system, because of its flexible nature, is not confined to support a load such as construction material solely within the bed of the truck, but may be utilized with a load that is partially outside or fully outside the truck bed by utilizing the rotational ability of the device.

In summary, the present invention generally relates to systems and methods for a hidden rack system. More specifically, the present invention relates to systems and methods for a hidden telescoping rack system to be utilized in truck beds.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a perspective view of the hidden rack system in accordance with embodiments of the disclosure;

FIG. 2 is a right-side perspective sequential view of the hidden rack system displaying three varying positions in accordance with embodiments of the disclosure;

FIG. 3 is a left-side perspective sequential view of the hidden rack system displaying three varying positions in accordance with embodiments of the disclosure;

FIG. 4 is an environmental view of the hidden rack system in a fully extended position in accordance with embodiments of the disclosure;

FIG. 5 is an environmental view of the hidden rack system in the fully extended position exemplifying the device's use for carrying construction material in accordance with embodiments of the disclosure;

FIG. 6 is an environmental view of the hidden rack system in the fully compressed position in accordance with embodiments of the disclosure;

FIG. 7 is an environmental view of the hidden rack system, displaying the device in a fully compressed position, so it is hidden below the walls of the truck bed in accordance with embodiments of the disclosure;

FIG. 8 is an environmental view of the hidden rack system in a mid-extended position in accordance with embodiments of the disclosure;

FIG. 9 is an environmental view of the hidden rack system, displaying an example of the use of a single rack to carry construction material in accordance with embodiments of the disclosure;

FIG. 10 is an environmental view of the hidden rack system rotated approximately 180 degrees around the vertical axis of the device in accordance with embodiments of the disclosure;

FIG. 11 is an environmental view of the hidden rack system rotated approximately 180 degrees around the vertical axis of the device, exemplifying the device's use in a rotated position to support construction material in accordance with embodiments of the disclosure;

FIG. 12 is an environmental view of the hidden rack system rotated approximately 180 degrees around the vertical axis of the device, exemplifying an alternative ability to support construction material, while in a rotated position, in accordance with embodiments of the disclosure.

### DETAILED DESCRIPTION OF THE INVENTION

Disclosed herein are improved systems and methods for a hidden rack system.

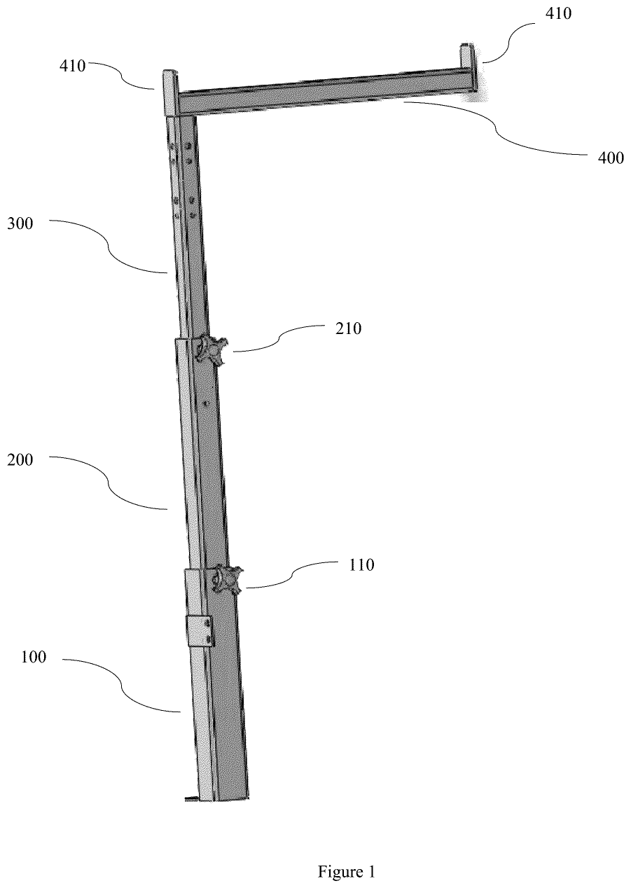

Reference is first made to FIG. 1, a perspective view of the hidden rack system in accordance with embodiments of the disclosure. Displayed is the hidden rack system in its fully extended position. The base member 100 is the largest in size. The intermediate member 200 is smaller than the base member 100 but larger than the top member 300 so that it may be housed in the base member 100. The top member 300 is the smallest in size and contains a fixed, horizontal member 400, positioned 90 degrees from the vertical axis of the device. The horizontal member 400 contains two raised portions 410, on opposing ends of the horizontal member 400. The raised portions 410 provide a stable and secure surface for equipment to be placed so it does not slide off. Threaded knobs 110 and 210 secure the telescoping members in the extended position.

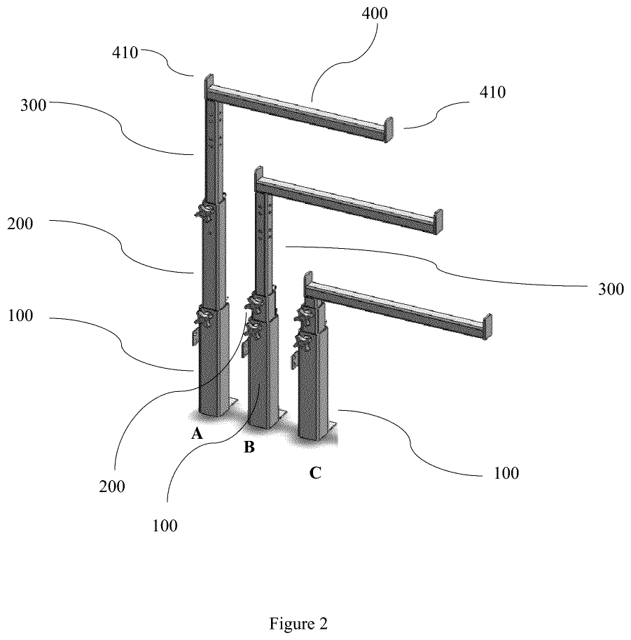

Reference is next made to FIG. 2, a right-side perspective sequential view of the hidden rack system displaying three positions in accordance with embodiments of the disclosure. FIG. 2-A, displays the device in its fully extended position. All members including the base member 100, the intermediate member 200, and top member 300 are visible. The horizontal member 400 and the two raised portions 410 are also displayed. FIG. 2-B displays the device in its partially expanded position. The base member 100 remains fully expanded, as the base it does not compress but provides a housing for the intermediate member 200 to be housed in. The intermediate member is compressed by sliding into the housing by the base member where it can be secured with the threaded knobs more clearly displayed in FIG. 1. FIG. 2-C displays the device in its fully compressed position. The base member 100, houses the intermediate member and top member. The horizontal member 400 remains extended even when the top member is compressed so that the device can be utilized in all positions.

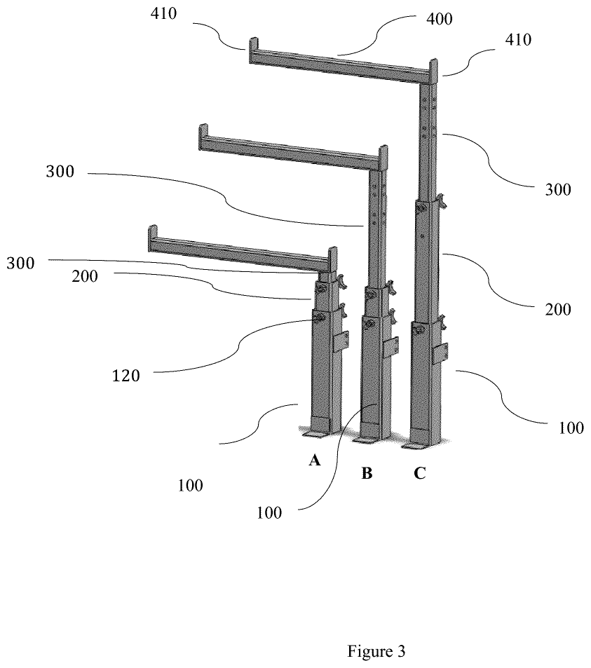

Reference is now made to FIG. 3, a left-side perspective sequential view of the hidden rack system displaying three positions in accordance with embodiments of the disclosure. FIG. 3-A displays the device in its fully compressed position. The top member 300 and intermediate member 200 are housed in the base member 100. The telescoping members are locked into place by the threaded knobs and spring-loaded pin 120. FIG. 3-B displays the device in its partially extended portion. The top member 300 is extended while the intermediate member is housed in the base member 100. FIG. 3-C displays the device in its fully extended position.

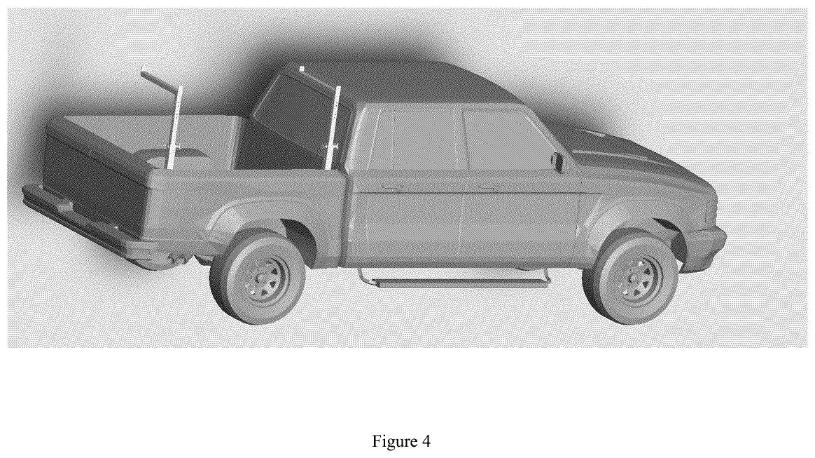

Reference is next made to FIG. 4, an environmental view of the hidden rack system in a fully extended position in accordance with embodiments of the disclosure.

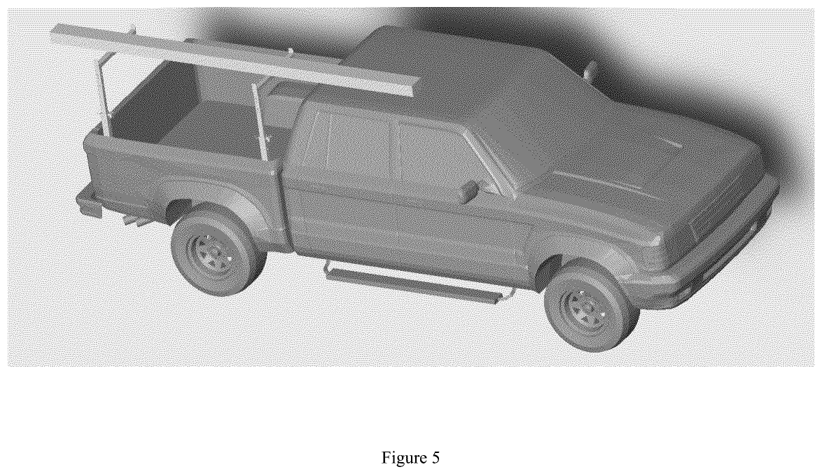

Reference is now made to FIG. 5, an environmental view of the hidden rack system in the fully extended position exemplifying the device's use for carrying construction material in accordance with embodiments of the disclosure.

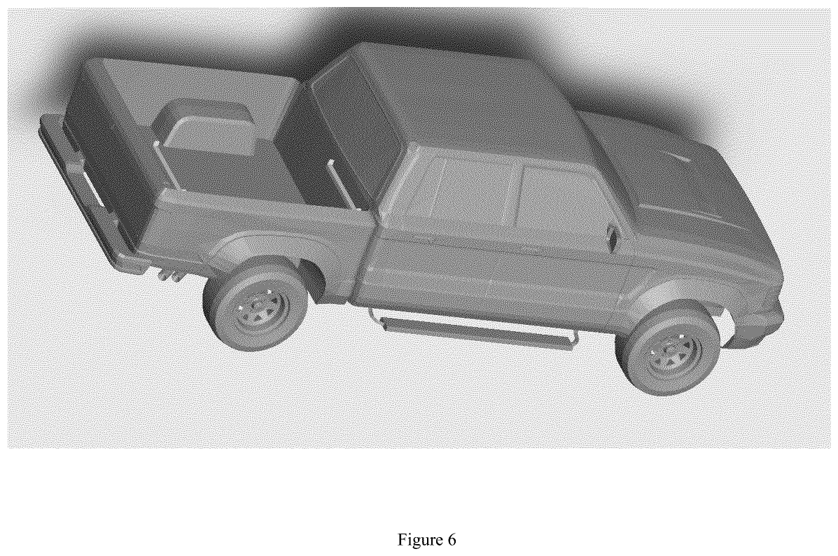

Reference is next made to FIG. 6, an environmental view of the hidden rack system in the fully compressed position in accordance with embodiments of the disclosure.

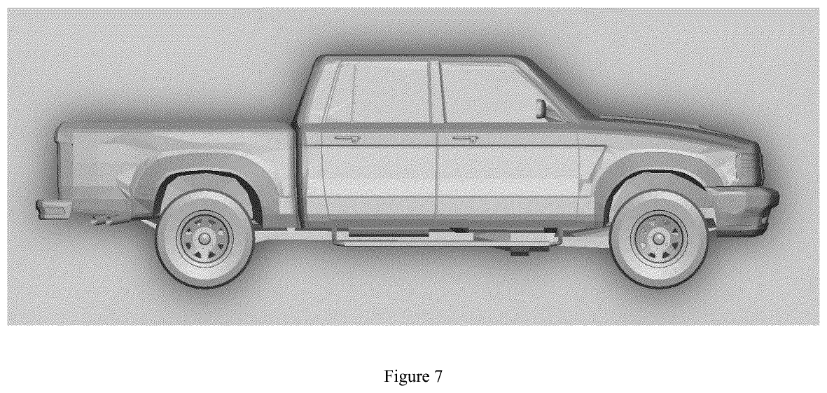

Reference is now made to FIG. 7, an environmental view of the hidden rack system, displaying the device in a fully compressed position, so they are hidden below the walls of the truck bed in accordance with embodiments of the disclosure.

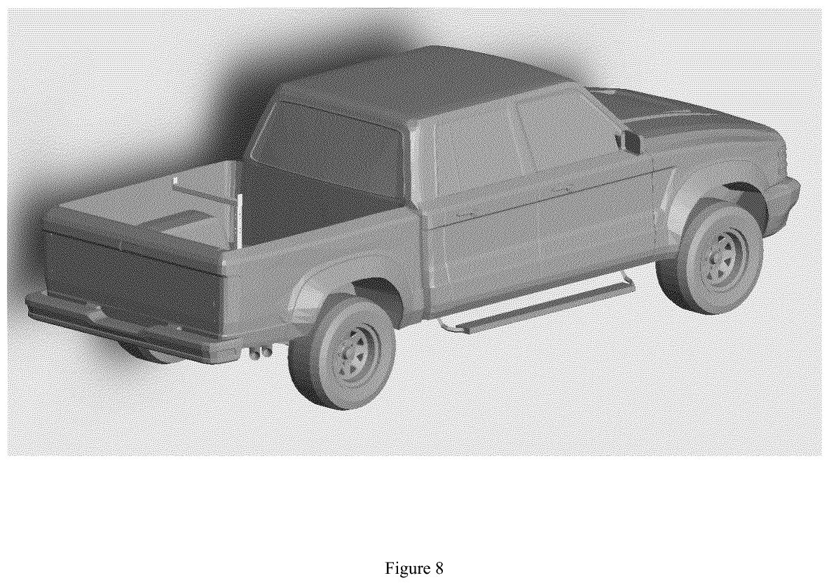

Reference is next made to FIG. 8, an environmental view of the hidden rack system in a mid-extended position in accordance with embodiments of the disclosure.

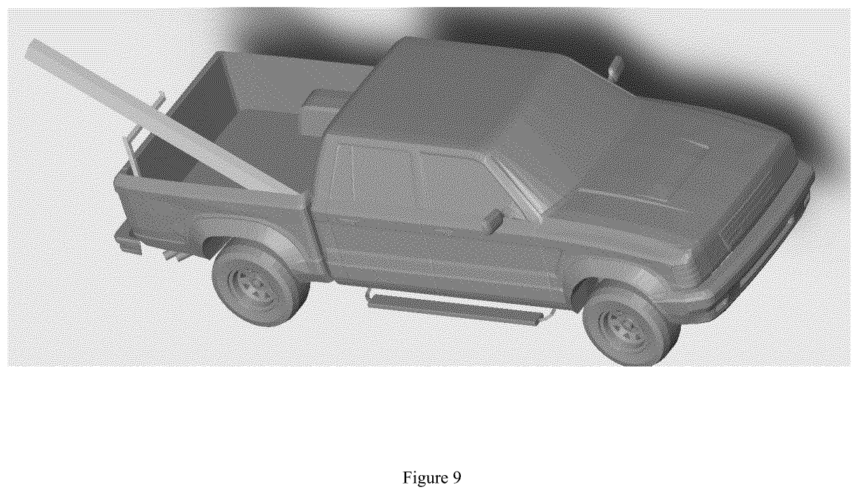

Reference is now made to FIG. 9, an environmental view of the hidden rack system, displaying an example of the use of a single rack to carry construction material in accordance with embodiments of the disclosure.

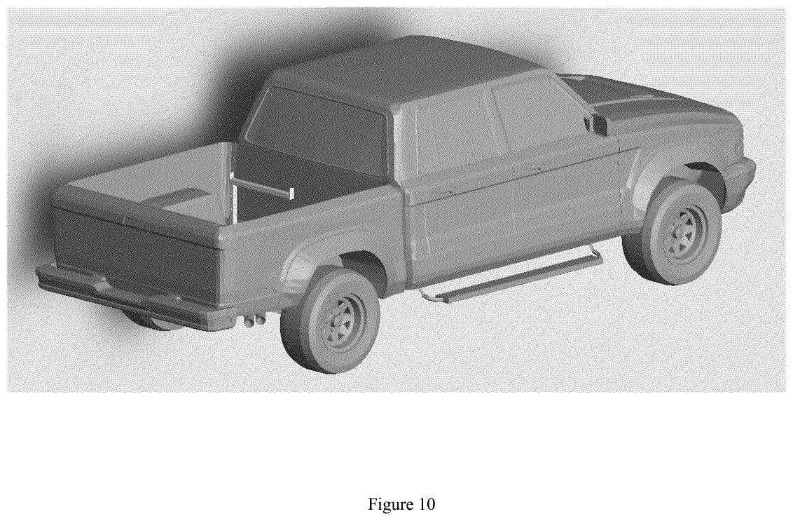

Reference is next made to FIG. 10, an environmental view of the hidden rack system rotated approximately 180 degrees around the vertical axis of the device in accordance with embodiments of the disclosure.

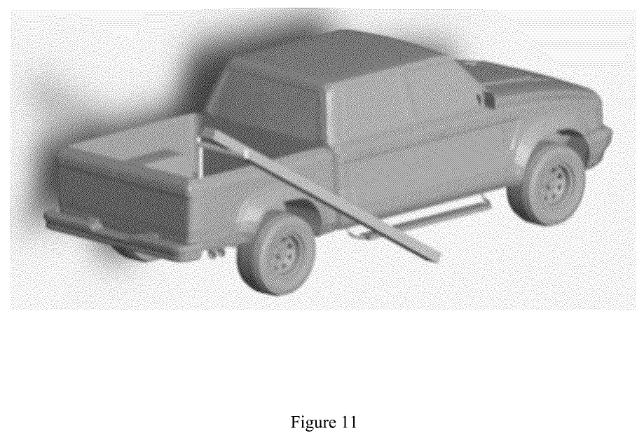

Reference is now made to FIG. 11, an environmental view of the hidden rack system rotated approximately 180 degrees around the vertical axis of the device, exemplifying the device's use in a rotated position to support construction material in accordance with embodiments of the disclosure.

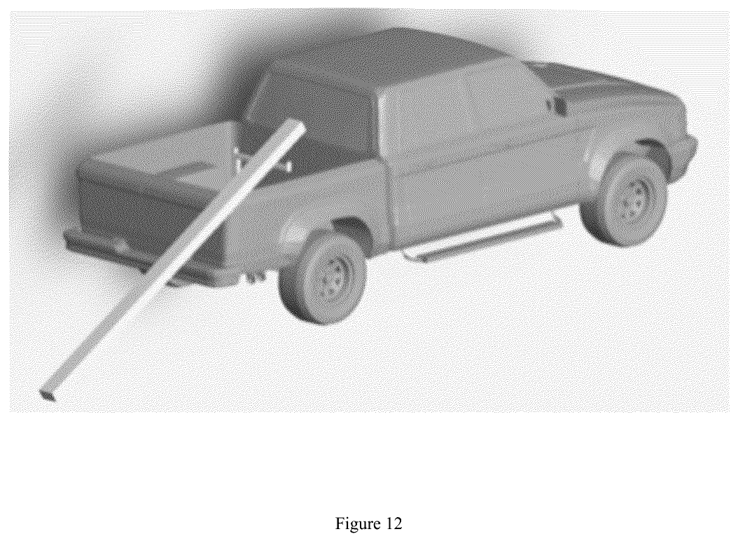

Reference is lastly made to FIG. 12, an environmental view of the hidden rack system rotated approximately 180 degrees around the vertical axis of the device, exemplifying an alternative ability to support construction material, while in a rotated position, in accordance with embodiments of the disclosure.

In brief, the invention is directed to a hidden rack system.

The disclosed systems and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed systems or methods, except as may be outlined in the claims.

Any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods disclosed and claimed herein can be made and executed without undue experimentation in light of the present disclosure. While the systems and methods of this invention have been described in terms of preferred embodiments, it will be apparent to those skilled in the art that variations may be applied to the systems and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A hidden rack system as herein disclosed.

2. A method of use for a hidden rack system as herein disclosed.
